(19) United States
(12) Patent Application Publication
(10) Pub. No.: US 2019/0221832 A1
(43) Pub. Date: Jul. 18, 2019

(54) ANODE MIXTURE FOR ALL-SOLID-STATE LITHIUM ION SECONDARY BATTERIES, AND METHOD FOR PRODUCING THE ANODE MIXTURE

(71) Applicant: Toyota Jidosha Kabushiki Kaisha, Toyota-shi Aichi-ken (JP)

(72) Inventor: Satoshi Wakasugi, Susono-shi Shizuoka-ken (JP)

(73) Assignee: Toyota Jidosha Kabushiki Kaisha, Toyota-shi Aichi-ken (JP)

(21) Appl. No.: 16/246,950

(22) Filed: Jan. 14, 2019

(30) Foreign Application Priority Data
Jan. 16, 2018 (JP) 2018-005026

(51) Int. Cl. H01M 4/134; H01M 4/1395; H01M 4/38; H01M 4/62; H01M 10/0525; H01M 10/0562

(52) U.S. Cl. CPC H01M 4/134; H01M 4/1395; H01M 4/386; H01M 2004/027; H01M 4/625; H01M 10/0525; H01M 10/0562; H01M 4/622

(57) ABSTRACT

Provided is an anode mixture for all-solid-state lithium ion secondary batteries, which comprises an anode active material comprising Si and which can suppress an increase in internal resistance of all-solid-state lithium ion secondary batteries. Also provided is a method for producing the anode mixture. An anode mixture for all-solid-state lithium ion secondary batteries, comprising an anode active material. (A), a solid electrolyte (B), an electroconductive material (C) and a binder (D), wherein the anode active material (A) comprises Si; wherein the solid electrolyte (B) comprises a sulfide solid electrolyte; wherein the electroconductive material (C) comprises a fibrous carbon material having six-membered carbon rings; and wherein the binder (D) comprises a polymer compound having aromatic rings.

### CROSS REFERENCE TO RELATED APPLICATIONS

This application claims priority to Japanese Patent Application No. 2018-005026 filed on Jan. 16, 2018, the entire contents of which are hereby incorporated by reference.

### TECHNICAL FIELD

The disclosure relates to an anode mixture for all-solid-state lithium ion secondary batteries, and a method for producing the anode mixture.

### BAGKGROUND

An active material containing a metal that can form an alloy with Li (an alloy-based active material) has a large theoretical capacity per volume, compared to a carbon-based anode active material. Therefore, a lithium ion battery using such an alloy-based active material in the anode, has been proposed.

Especially, due to its large capacity, Si attracts attention as a metal that is able to form an alloy with Li.

Patent, Literature 1 discloses an anode mixture for lithium ion batteries, which comprises, as an anode active material powder, a powder of anode active material particles composed of a metal or alloy that allows lithium ion insertion and elimination. Patent Literature 1 also discloses, in Examples, an anode mixture produced by use of a powder of elemental Si as the anode active material powder.

Patent Literature 1: Japanese Patent. Application Laid-Open No. 2013-069416

However, it was found that the all-solid-state lithium ion secondary battery as disclosed in Patent Literature 1, comprising an anode in which an anode mixture comprising a Si-containing anode active material is used, causes a large increase in internal resistance when it repeats charge and discharge cycles.

### SUMMARY

In light of the above circumstance, an object of the present disclosure is to provide an anode mixture for all-solid-state lithium ion secondary batteries, which comprises an anode active material comprising Si and which can suppress an increase in internal resistance of all-solid-state lithium ion secondary batteries. Another object of the present disclosure is to provide a method for producing the anode mixture.

In a first embodiment, there is provided an anode mixture for all-solid-state lithium ion secondary batteries, comprising an anode active material (A), a solid electrolyte (B), an electroconductive material (C) and a binder (D), wherein the anode active material (A) comprises Si; wherein the solid electrolyte (B) comprises a sulfide solid electrolyte; wherein the electroconductive material (C) comprises a fibrous carbon material having six-membered carbon rings; and wherein the binder (D) comprises a polymer compound having aromatic rings.

In the anode mixture, vapor-grown carbon fibers may be contained as the fibrous carbon material.

The fibrous carbon material may have an aspect ratio of from 10 to 100 and a fiber diameter of from 10 nm to 600 nm.

In the anode mixture, at least one selected from the group. consisting of styrene-butadiene rubber and a styrene-isobutylene-styrene copolymer may be contained as the polymer compound.

In the anode mixture, at least one lithium compound selected from the group consisting of Li₂S, LiBr and LiI, and at least one sulfur compound selected from the group consisting of P₂S₅ and SiS₂ may be contained as the sulfide solid electrolyte.

In another embodiment, there is provided a method for producing an anode mixture for all-solid-state lithium ion secondary batteries, the method comprising: an anode mixture raw material preparing step (I) of preparing an anode mixture raw material comprising an anode active material (A) comprising Si, a solid electrolyte (B) comprising a sulfide solid electrolyte, an electroconductive material (C) comprising a fibrous carbon material having six-membered carbon rings, a binder (D) comprising a polymer compound having aromatic rings, and an organic solvent (E) having aromatic rings, and a drying step (II) of drying the anode mixture raw material.

The production method may comprise, before the drying step (II), an applying step of applying the anode mixture raw material to a substrate, and the applied anode mixture raw material may be dried in the drying step (II).

Vapor-grown carbon fibers may be used as the fibrous carbon material.

The fibrous carbon material may have an aspect ratio of from 10 to 100, and a fiber diameter of from 10 nm to 600 nm.

At least one selected from the group consisting of styrene-butadiene rubber and a styrene-isobutylene-styrene copolymer may be used as the polymer compound.

At least one selected from the group consisting of 1,3,5-trimethylbenzene, isopropylbenzene and methyl phenyl ether may be used as the organic solvent (E).

According to the present disclosure, an anode mixture for all-solid-state lithium ion secondary batteries can be provided, which comprises an anode active material comprising Si and which can suppress an increase in internal resistance of all-solid-state lithium ion secondary batteries.

### BRIEF DESCRIPTION OF THE DRAWINGS

In the accompanied drawings,

FIG. 1A is a schematic view showing the state of an aromatic ring of a polymer compound in a binder (D) or an aromatic ring of an organic solvent (E), before the aromatic ring enters an aggregate of a fibrous carbon material;

FIG. 1B is a schematic view showing the state when an aromatic ring of the polymer compound in the binder (D) or an aromatic ring of the organic solvent (E) enters the aggregate of the fibrous carbon material; and

FIG. 2 is a schematic view of an example of the structure of an all-solid-state lithium ion secondary battery.

### DETAILED DESCRIPTION

### 1. Anode Mixture

The anode mixture of the present disclosure is an anode mixture for all-solid-state lithium ion secondary batteries, comprising an anode active material (A), a solid electrolyte (B′), an electroconductive material (C) and a binder (D), wherein the anode active material (A) comprises Si; wherein the solid electrolyte (B) comprises a sulfide solid electrolyte; wherein the electroconductive material (C) comprises a fibrous carbon material having six-membered carbon rings; and wherein the binder (D) comprises a polymer compound having aromatic rings.

A metal that can form an alloy with Li, is low in ion conductivity and electron conductivity. Therefore, when the metal is used as an anode active material, an electroconductive material and a solid electrolyte are generally incorporated in an anode, in combination with, the anode active material.

Also, when the metal that can form an alloy with Li (hereinafter, the metal may be referred to as M) is used as the anode active material, along with charging a lithium ion secondary battery, a so-called electrochemical alloying reaction as shown by the following formula (1) occurs in the anode:

xLi⁺+xe⁻+yM→LiₓM_{y} Formula (I)

Also, along with discharging the lithium ion secondary battery, a reaction as shown by the following formula (2) occurs in the anode, which is an elimination reaction of Li ions from the alloy of Si and Li:

LiₓM_{y}→xLi⁺+xe⁻+yM Formula (2)

The lithium ion secondary battery in which the metal that can form an alloy with Li is used as the anode active material, undergoes a large volume change along with the Li insertion and elimination reactions shown by the above formulae (1) and (2).

It was found that along with charging and discharging the all-solid-state lithium ion secondary battery as disclosed in Patent Literature 1, the battery undergoes large volume expansion and contraction of the anode active material; therefore, as a result of repeating charging and discharging, a part where contact between the anode active material and the electroconductive material is not maintained (hereinafter referred to as poor contact part) is formed, and electron conduction is blocked in the poor contact part and results in a large increase in internal resistance.

The mechanism of formation of the poor contact part between the electroconductive material and the anode active material in the anode comprising the Si-containing anode active material, is as follows.

First, at the time of Li ion insertion (at the time of charging), the anode active material undergoes large volume expansion; moreover, the electroconductive material around the anode active material is pushed by the expanded anode active material and moved from the position where it was before the Li ion insertion. Then, at the time of Li ion elimination (at the time of discharging), the anode active material undergoes volume contraction, and the moved electroconductive material cannot follow the volume: contraction of the anode active material, thereby forming the poor contact part between the electroconductive material and the anode active material.

By using the anode mixture of the present disclosure in an all-solid-state lithium ion secondary battery, an increase in internal resistance along with repeating charging and discharging the battery, can be suppressed. The mechanism is estimated as follows.

The fibrous carbon material has a large aspect ratio and a crystal, structure elongated in one direction. Therefore, for example, when compared to a carbon material having a flaky crystal structure, the fibrous carbon material is advantageous in that a contact part with the anode active material can be more easily obtained. On the other hand, the fibers of the fibrous carbon material easily aggregate, and the fibers constituting the aggregate are less likely to disperse in the anode mixture. Therefore, the fibrous carbon material has a disadvantage of limited contact with the anode active material.

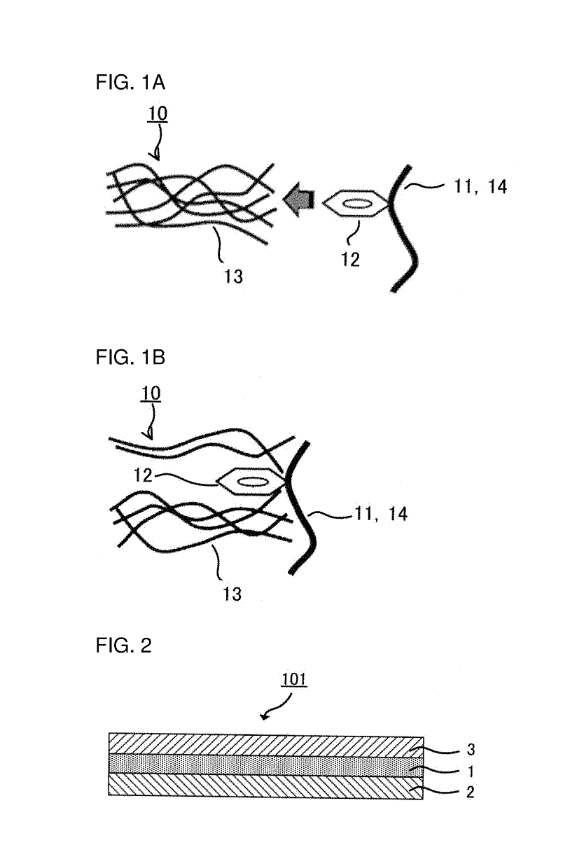

FIG. 1A is a schematic view showing the state of an aromatic ring of the polymer compound in the binder (D) or an aromatic ring of the organic solvent (E), before the aromatic ring enters an aggregate of the fibrous carbon material. FIG. 1B, is a schematic view showing the state when an aromatic ring of the polymer compound in the binder (D) or an aromatic ring of the organic solvent (E) enters the aggregate of the fibrous carbon material. The fibrous carbon material and binder (D) of the present disclosure are not limited to the embodiments shown in these figures.

In the anode mixture of the present disclosure, as shown in FIG. 1A, part of aromatic rings 12 of a polymer compound 11 contained in the binder (D) approach an aggregate 10 of a fibrous carbon material 13 contained in the electroconductive material (C) from, for example, the long axis direction of the aggregate 10 of the fibrous carbon material, enter the inside of the aggregate 10, and dissociate the aggregation of the fibrous carbon material 13. Also, as shown in FIG. 1B, spaces in the fibrous carbon material are extended by electrostatic repulsion created between the six-membered carbon rings of the fibrous carbon material 13 and the n electrons of the aromatic rings 12 that entered the inside of the aggregate 10. Therefore, by using the electroconductive material (C) comprising the fibrous carbon material having the six-membered carbon rings and the binder (D) comprising the polymer compound having the aromatic rings, the dispersibility of the fibrous carbon material in the anode mixture is increased, and the part where the fibrous carbon material can contact with the anode active material (A) is increased.

Therefore, even if the anode active material (A) undergoes volume expansion and contraction when the all-solid-state lithium ion secondary battery using the anode mixture of the present disclosure repeats charge and discharge cycles, the contact between the fibrous carbon material and the anode active material (A) is easily maintained. Therefore, the formation of the poor contact part between the electroconductive material (C) and the anode active material (A) along with repeating charging and discharging, can be suppressed, and an increase in internal resistance can be suppressed. The entry of the aromatic rings 12 is not limited to the embodiment shown in FIG. 1B. For example, the aromatic rings 12 may enter the inside of the aggregate 10 from the direction approximately perpendicular to the Long axis direction of the aggregate 10, through the spaces of the fibrous carbon material 13. Also, the aromatic rings 12 may enter the inside of the aggregate 10 from the direction tilted at a given angle to the long axis direction of the aggregate 10, through the spaces of the fibrous carbon material 13.

Hereinafter, the anode active material (A), the solid electrolyte (B), the electroconductive material and the binder (D) will be explained in this order.

### (Anode Active Material (A))

The anode active material (A) comprises Si.

The percentage of the anode active material (A) in the anode mixture is not particularly limited. For example, it may be 40% by mass or more, may be in a range of from 50% by mass to 90% by mass, or may be in a range of from 50% by mass to 70% by mass.

The form of the anode active material (A) is not particularly limited. As the form, examples include, but are not limited to, a particulate form and a film form.

### (Solid Electrolyte (B))

As the solid electrolyte (B), a sulfide solid electrolyte is used.

The sulfide solid electrolyte may contain a compound containing Li and a compound containing S. As the sulfide solid electrolyte, for example, at least one lithium compound selected from the group consisting of Li₂S, LiBr and LiI, and at least one sulfur compound selected from the group consisting of P₂S₅ and SiS₂, may be contained. As the sulfide solid electrolyte, examples include, but are not limited to, Li₂S—SiS₂, LiI—Li₂S—SiS₂, LiI—Li₂S—P₂⁵₅, LiI—Li₂S—P₂O₅, LiI—Li₃PO₄—P₂S₅, Li₂S—P₂S₅—LiBr,l Li₂S—P₂S₅, and LiI-LiBr—Li₂S—P₂S₅. Also, as the sulfide solid electrolyte, examples include, but are not limited to, LGPS-based solid electrolytes such as Li₁₀GeP₂S₁₂.

The percentage of the solid electrolyte (B) in the anode mixture is not particularly limited. For example, it may be 10% by mass or more, may be in a range of from 20% by mass to 50% by mass, or may be in a range of from 25% by mass to 45% by mass.

The raw material for the solid electrolyte (B) may have a density of from 2.0 g/cm³ to 2.5 g/cm³.

An example of the method for preparing the solid electrolyte (B) will be explained below.

First, the raw material for the solid electrolyte (B), a dispersion Medium and dispersing balls are put in a container. Using the container, mechanical milling is carried out to pulverize the raw material for the solid electrolyte. Then, a mixture thus obtained is appropriately heated, thereby obtaining the solid electrolyte (B).

### (Electroconductive Material (C))

The electroconductive material (C) comprises a fibrous carbon material having six-membered carbon rings.

In the present disclosure, the fibrous carbon material is not particularly limited, as long as it is a carbon material that has a crystal structure elongated in one direction and six-membered carbon rings. Since the electroconductive material (C) contains the fibrous carbon material having the six-membered carbon rings, the contact part with the anode active material (A) is easily obtained in the fibrous carbon material. Therefore, the electroconductive material (C) is in good contact with the anode active material (A).

The fibrous carbon material may be a fibrous carbon material having an aspect ratio of from 10 to 100 and a fiber diameter of from 10 nm to 600 nm.

In the present disclosure, the aspect ratio is obtained as follows: 200 carbon fibers are randomly selected and observed with a scanning electron microscope (SEM); for each carbon fiber, the diameter a of a section, the length b, and the ratio b/a are obtained; and the average of the ratios of the carbon fibers is determined as the aspect ratio.

Also in the present disclosure, the fiber diameter is an average of the diameters of the sections of the randomly selected 200 carbon fibers observed with the scanning electron microscope (SEM).

In some embodiments, the aspect ratio of the fibrous carbon material is from 20 to 70, such as from 30 to 50. In some embodiments, the fiber diameter of the fibrous carbon material is from 50 nm to 400 nm, such as from 100 nm to 200 nm.

By using the fibrous carbon material having the six-membered carbon rings as the electroconductive material (C), as shown in FIG. 1B, electrostatic repulsion is created between the six-membered carbon rings of the fibrous carbon material 13 and the n electrons of the aromatic rings 12 of the polymer compound 11 contained in the binder (D). By this electrostatic repulsion, the spaces in the fibrous carbon material 13 are extended to increase the dispersibility of the fibrous carbon material 13.

The fibrous carbon material having the six-membered carbon rings may be, for example, at least one kind of carbon material selected from the group consisting of carbon nanotubes and carbon nanofibers. The carbon nanotubes and the carbon nanofibers may be vapor-grown carbon fibers (VGCF).

The percentage of the electroconductive material (C) in the anode mixture may be 1.0% by mass or more, may be in a range of from 1.0% by mass to 12.0% by mass, or may be in a range of from 2.0% by mass to 10.0% by mass, of the total mass of the anode mixture.

As the electroconductive material (C), a carbon material other than the fibrous carbon material having the six-membered carbon rings may be contained in a range of 5% by mass or less of the total mass of the electroconductive material (C). As the carbon material other than the fibrous carbon material having the six-membered carbon rings, examples include, but are not limited to, carbon blacks such as acetylene black, Ketjen black and furnace black.

### (Binder (D))

The binder (D) comprises a polymer compound having aromatic rings.

As described above, the dispersibility of the fibrous carbon material contained in the electroconductive material (B) is increased by using the polymer compound having the aromatic rings as the binder (D).

As the polymer compound having, the aromatic rings, for example, at least one selected from the group consisting of the following polymer compounds can be used: styrene-butadiene rubber (SBR), a styrene-isobutylene-styrene copolymer (SIBS), a styrene-isobutylene copolymer (SIB), a styrene-butadiene-styrene copolymer (SBS), a styrene-ethylene-butylene-styrene copolymer (SEBS), a styrene-isoprene-styrene copolymer (SIS) and a styrene-ethylene-propylene-styrene copolymer (SEPS).

From the viewpoint of increasing the dispersibility of the fibrous carbon material, the binder (D) may be at least one selected from the group consisting of styrene-butadiene rubber (SBR) and a styrene-isobutylene-styrene copolymer (SIBS).

In the anode mixture, the percentage of the binder (D) may be 0.1% by mass or more, may be in a range of from 0.1% by mass to 2.0% by mass, or may be in a range of from 0.2% by mass to 1.0% by mass of the total mass of the anode mixture.

As the binder (D), a polymer compound other than the polymer compound having the aromatic rings may be contained in a range of 5% by mass or less of the total mass of the binder (D). As the polymer compound other than the polymer compound having the aromatic rings, examples include, but are not limited to, polyvinylidene fluoride (PVdF), polytetrafluoroethylene (PTFE), butylene rubber (BR), polyvinyl butyral (PVB) and acrylic resin.

The ratio of the electroconductive material (C) and binder (D) contained in the anode mixture may be as follows: with respect to 1 part by mass of the electroconductive material (C), the binder (D) is in a range of from 0.1 part by mass to 1 part by mass, such as a range of from 0.1 part by mass to 0.5 part by mass.

In addition to the above components, the anode mixture may contain other component.

In the anode mixture of the present disclosure, the percentage of the components other than the anode active material (A) may be small, since the energy density of the anode increases.

### 2. Method for Producing Anode Mixture

The anode mixture production method of the present disclosure is a method for producing an anode mixture for all-solid-state lithium ion secondary batteries, the method comprising: an anode mixture raw material preparing step (I) of preparing an anode mixture raw material comprising an anode active material (A) comprising Si, a solid electrolyte (B) comprising a sulfide solid electrolyte, an electroconductive material (C) comprising a fibrous carbon material having six-membered carbon rings, a binder (D) comprising a polymer compound having aromatic rings, and an organic solvent (E) having aromatic rings, and a drying step (II) of drying the anode mixture raw material.

Hereinafter, in FIGS. 1A and 1B, the polymer compound 11 contained in the binder (D) may be replaced by an organic solvent (E) 14.

In the anode mixture production method of the present disclosure, the electroconductive material (C) comprising the fibrous carbon material having the six-membered carbon rings, the binder (D) comprising the polymer compound having the aromatic rings, and the organic solvent (E) having the aromatic rings, are used. Therefore, as shown in FIG. 1A, in the anode mixture raw material, part of the aromatic rings 12 of the polymer compound 11 contained in the binder (D) and part of the aromatic rings 12 of organic solvent (E) 14 approach the aggregate 10 of the fibrous carbon material 13 from the long axis direction of the aggregate 10, enter the inside of the aggregate 10 and dissociate the aggregation of the fibrous carbon material 13 in the anode mixture raw material.

Also, as shown in FIG. 1B, in the anode mixture raw material, the spaces in the fibrous carbon material 13 are extended by electrostatic repulsion created between the six-membered carbon rings of the fibrous carbon material 13 and the n electrons of the aromatic rings 12 of the polymer compound 11 and of the aromatic rings 12 of the organic solvent (E) 14, which entered the inside of the aggregate 10.

Due to the above reason, the dispersibility of the fibrous carbon material in the anode mixture raw material is increased by using the electroconductive material, (C) comprising the fibrous carbon material having the six-membered carbon rings, the binder (D) comprising the polymer compound having the aromatic rings, and the organic solvent (E) having the aromatic rings Therefore, after the anode mixture raw material is dried, the anode mixture in which the dispersibility of the fibrous carbon material is increased and the part where the fibrous carbon material can contact with the anode active material (A) is increased, can be obtained.

Therefore, even if the anode active, material (A) undergoes volume expansion and contraction when charge and discharge cycles are repeated by the all-solid-state lithium ion secondary battery comprising the anode mixture produced by the production method of the present disclosure, the contact between the fibrous carbon material and the anode active material (A) is easily maintained. Therefore, the formation of the poor contact part between the electroconductive material (C) and the anode active material (A) along with repeating charging and discharging, can be suppressed, and an increase in internal resistance can be suppressed.

As described above, the entry of the aromatic rings 12 is not limited to the embodiment shown in FIG. 1B.

### (I) Anode Mixture Raw Material Preparing Step

The anode mixture raw material prepared in this step contains the anode active material (A), the solid electrolyte (B), the electroconductive material (C), the binder (D) and the organic solvent (E).

As the anode active material (A), the solid electrolyte (B), the electroconductive material (C) and the binder (D), the same materials as those described above in “1. Anode mixture” can be used. The ratio of the anode active material (A), the solid electrolyte (B), the electroconductive material (c) and the binder (D) contained in the anode mixture raw material, can be determined by weighing out and incorporating the components (A) to (D) at the ratio described above in “1. Anode mixture” in solid content equivalent.

### (Organic Solvent (E))

As the organic solvent (E), an organic solvent having aromatic rings is used.

As described above, by using the organic solvent having the, aromatic rings as the organic solvent (E), the dispersibility of the fibrous carbon material is increased in the anode mixture raw material and in the anode mixture obtained by drying the anode, mixture raw material.

As the organic solvent (E) having the aromatic rings, for example, at least one kind of organic solvent selected from the group consisting of toluene, xylene (including ionomers), 1,2,3-trimethylbenzene, 1,2,4-trimethylbenzene, 1,3,5-trimethylbenzene, ethylbenzene, diethylbenzene (including ionomers), propylbenzene, isopropylbenzene and methyl phenyl ether, can be used.

From the viewpoint of increasing the dispersibility of the fibrous carbon material, the organic solvent (E) may be at least one selected from the group consisting of 1,3,5-trimethylbenzene, isopropylbenzene and methyl phenyl ether.

However, in some embodiments the organic solvent having the aromatic rings which is contained in the anode mixture raw material, is not an organic solvent in which a hydroxyl group and/or a carboxyl group is contained per molecule. This is because such an organic solvent may react with the sulfide solid electrolyte in the anode mixture raw material and decrease the Li ion conductivity of the sulfide solid electrolyte. When the anode mixture containing the sulfide solid electrolyte having decreased Li ion conductivity, is used in the all-solid-state lithium ion secondary battery, the battery performance may decrease. As the organic solvent in which a hydroxyl group and/or a carboxyl group is contained per molecule, examples include, but are not limited to, cresol and benzoic acid. In some embodiments they are not contained in the anode mixture raw material.

In some embodiments, the organic solvent having the aromatic rings which is contained in the anode mixture raw material, is not an organic solvent in which a halogen atom is contained per molecule. This is because when such an organic solvent remains in the anode mixture, it may cause an electrochemical reaction and decompose in the anode mixture. When the anode mixture containing a decomposition product of the organic solvent containing a halogen atom, is used in the all-solid-state lithium ion secondary battery, the battery performance may decrease. As the organic solvent containing a halogen atom per molecule, examples include, but are not limited to, chlorobenzene and bromobenzene. In some embodiments, they are not contained in the anode mixture raw material.

The percentage of the organic solvent (E) in the anode mixture raw material may be 30% by mass or more, may be in a range of from 40% by mass to 80% by mass, or may be in a range of from 45% by mass to 60% by mass of the total mass of the anode mixture raw material.

The method for preparing the anode mixture raw material is not particularly limited. For example, the anode mixture raw material is obtained by stirring a mixture of the anode active material (A), the solid electrolyte (B), the electroconductive material (C), the binder (D) and the organic solvent (E) with an ultrasonic disperser, a shaker, or the like.

In some embodiments, the anode active material (A), the solid electrolyte (B), the electroconductive material (C) and the binder (D) are dispersed by use of the organic solvent (E) to prepare the anode mixture raw material in a paste form, and the applying step of applying the anode mixture raw material in a paste form to a substrate is carried out before the drying step (II).

In the case of producing the anode mixture raw material in a paste form, the dispersing method is not particularly limited. For example, it may be a dispersing method using a homogenizer, a bead mill, a shear mixer, a roll mill, or the like.

### (II) Drying Step

In this step, the anode mixture raw material obtained in the anode mixture raw material preparing step (I) is dried.

For example, in the case of carrying out the above-mentioned applying step, the anode mixture raw material applied to the substrate is dried and appropriately fired for removal of the organic solvent (E), thereby forming the anode mixture in a film form on the substrate.

For example, the anode mixture raw material in a paste form prepared in the (I) anode mixture raw material preparing step, is applied onto a solid electrolyte layer, an anode current collector layer, or the like. The method for applying the anode mixture raw material in a paste form may be appropriately selected from conventionally-known applying methods.

The method for drying the anode mixture raw material in a film form applied onto the substrate, is not particularly limited. For example, the drying method may be a drying method using a sufficiently-heated heat source, such as a hot plate.

The organic solvent (E) is almost completely removed in the drying step (II) of drying the anode mixture raw material. A slight amount of the organic solvent (E) may remain in the anode mixture obtained after drying.

The organic solvent (E) remaining in the anode mixture can be detected by gas chromatography mass spectrometry (GC-MS) or temperature programmed desorption mass spectrometry (TPD-MS), for example.

In the case of forming the anode mixture raw material comprising the fibrous carbon material into a film, it has been difficult to increase the dispersibility of the fibrous carbon material in the thus-obtained anode mixture, since the movable distance of the fibrous carbon material in the anode mixture raw material is limited.

In this step, due to the occurrence of the phenomena illustrated in FIGS. 1A and 1B, the dispersibility of the fibrous carbon material in the anode mixture raw material formed into a film, can be increased.

In the case of not applying the anode mixture raw material onto a substrate, for example, the anode mixture raw material is dried as it is and appropriately fired for removal of the organic solvent (E), thereby obtaining the anode mixture in a powder form.

In the case of drying the anode mixture raw material without applying the raw material onto a substrate, the drying method is not particularly limited. For example, the drying method may be a drying method using a sufficiently-heated heat source, such as a hot plate.

The anode mixture in a powder form may be subjected to compression forming, for example. In the case of compression forming of the anode mixture in a powdery form, generally, a press pressure of about 400 MPa to 1,000 MPa is applied. The anode mixture in a powder form may be subjected to roll pressing. In this case, a line pressure of 10 kN/cm to 100 kN/cm may be applied.

When a removable binder component is contained in the anode mixture raw material, the binder component may be removed as follows the anode mixture raw material is dried to obtain the anode mixture in a powder form, and the powder is subjected to compression forming and then fired, thereby removing the binder component.

### 3. All-Solid-State Lithium Ion Secondary Battery

The constitution of the all-solid-state lithium ion secondary battery of the present disclosure is not particularly limited, as long as the battery functions as a secondary battery and comprise an anode in which the above-mentioned anode mixture is contained. As shown in FIG. 2, typically, the all-solid-state lithium ion secondary battery of the present disclosure comprises a cathode 2, an anode 3 and a solid electrolyte layer 1 disposed between the cathode 2 and the anode 3, thereby forming a cathode-solid electrolyte layer-anode assembly 101. The cathode 2 may comprise a cathode current collector. The anode 3 may comprise an anode current collector. In this cathode-solid electrolyte layer-anode assembly 101, the cathode, the solid electrolyte layer and the anode may be arranged in this order and attached directly or through a component composed of a different material. It is also an assembly of members having such an arrangement structure that the component composed of a different material may be attached to the opposite side to the position where the solid electrolyte layer on the cathode is present (the outside of the cathode). and/or the opposite side to the position where the solid electrolyte layer on the anode is present (the Outside of the anode.

A cell, which is a functional unit of all-solid-state battery, is obtained by attaching other members (such as current collector) to the cathode-solid electrolyte layer-anode assembly 101. The cell may be used as it is as the all-solid-state lithium ion battery. Or, the cells may be stacked and electrically connected to fort a cell assembly, and the cell assembly may be used as the all-solid-state lithium ion battery Of the present disclosure.

For the cathode-solid electrolyte layer-anode assembly, in general, the thickness of the cathode and that of the anode are from about 0.1 μm to about 10 mm each, and the thickness of the solid electrolyte layer is from about 0.01 μm to about 1 mm.

### 3-1. Cathode

The cathode is not particularly limited, as long as it functions as the cathode of the all-solid-state lithium ion secondary battery. In general, the cathode comprises a cathode active material containing Li. As needed, it comprises other components such as a binder, a solid electrolyte and an electroconductive material.

In the present disclosure, the cathode active material containing Li is not particularly limited, as long as it is an active material Containing a Li element. A substance which functions, in relation to the anode active material, as a cathode active material in an electrochemical reaction and which develops an electrochemical reaction involving Li ion transfer, can be used as the cathode active material, without particular limitation. Also, a substance that is known as the cathode active material of a lithium ion battery can be used in the present disclosure.

The raw material for the cathode active material is not particularly limited, as long as it is a raw material that can be used in an all-solid-state lithium ion secondary battery. As the raw material, examples include, but are not limited to, lithium cobaltate (LiCoO₂), lithium nickelate (LiNiO₂), lithium manganate (LiMn₂O₄) Li₁₊ₓNi_{1/3}Mn_{1/3}Co_{1/3}O₂ (0≤x<0_.3), different element-substituted Li—Mn spinel with the composition represented by Li₁₊ₓMn_{2-x-y}M_{y}O₄ (where M is one or more kinds of elements selected from Al, Mg, Co, Fe, Ni and Zn), lithium titanate (LiₓTiO_{y}) and lithium metal phosphate (LiMPO₄ where M is Fe, Mn, Co, Ni or the like).

The cathode active material may have a coating layer that contains a substance which has lithium ion conductivity, which is not fluidized when it is in contact with an active material layer or solid electrolyte, and which can maintain the coating layer form even. As the substance, examples include, but are not limited to, LiNbO₃, Li₄Ti₅O₁₂ and Li₃PO₄.

The form of the cathode active material is not particularly limited. It may be a film form or a particulate form.

The percentage of the cathode active material in the cathode is not particularly limited. For example, it may be 60% bypass or more, may be in a range of from 70% by mass to 95% by mass, or may be in a range of from 80% by mass to 90% by mass.

As the binder contained in the cathode, for example, polyvinylidene fluoride (PVdF), polytetrafluoroethylene (PTFE), butylene rubber (BR), styrene-butadiene rubber (SBR), polyvinyl butyral (PVB), acrylic resin or the like can be used. The binder may be polyvinylidene fluoride (PVdF).

The percentage of the binder in the cathode may be 0.1% by mass or more, may be in a range of from 0.1% by mass to 1.0% by mass, or may be in a range of from 0.2% by mass to 0.7% by mass of the total mass of the cathode.

As the raw material for the solid electrolyte and the raw material for the electroconductive material, the same raw materials as those used in the anode can be used.

### 3-2. Solid Electrolyte Layer

The solid electrolyte layer is not particularly, limited, as long as it functions as the solid electrolyte of an all-solid-state lithium secondary battery. In general, it comprises a solid electrolyte raw material. As needed, it comprises other components such as a binder.

The raw material for the solid electrolyte and the raw material for the binder, the same raw materials as those used in the anode can be used.

The percentage of the solid electrolyte raw material in the solid electrolyte material layer is not particularly limited. For example, it may be 50% by mass or more, may be in a range of from 70% by mass to 99.99% by mass, or may be in a range of from 90% by mass to 99.9% by mass.

### EXAMPLES

### 1. Production of Anode Mixture

### Example 1

### (1) Step of Synthesizing Sulfide Solid Electrolyte

The following raw materials for a sulfide solid electrolyte were put in an agate mortar.
Lithium sulfide (Li₂S manufactured by Furuuchi Chemical Corporation, purity 99.9%) 0.550 g
Diphosphorus pentasulfide (P₂S₅ manufactured by Aldrich, purity 99%) 0.887 g
Lithium iodide (LiI manufactured by Nippoh Chemicals Co., Ltd., purity 99%) 0.285 g
Lithium bromide (LiBr manufactured by Kojundo Chemical Laboratory Co., Ltd.) 0.277 g

The raw materials were mixed in the agate mortar for 5 minutes to obtain a mixture. The mixture was put in the container of a planetary ball mill, and dehydrated heptane (manufactured by Kanto Chemical Co., Inc., 4 g) was put in the container. In addition, ZrO₂ balls were put in the container, and the container was hermetically closed, absolutely (in an Ar atmosphere). The container was installed in the planetary ball mill (manufactured by Fritsch) and subjected to mechanical milling for 4.0 hours at a plate rotational frequency of 300 rotations per minute. Then, the mixture was appropriately dried, thereby obtaining a sulfide solid electrolyte (LiI—LiBr—Li₂S—P₂S₅).

### (2) Step of Producing Anode Mixture

The following raw materials for the anode mixture were put in a container.
Anode active material (A): Si particles (manufactured by Kojundo Chemical Laboratory Co., Ltd.) 1.0 g (54% by mass)
Solid electrolyte (B): The above-mentioned sulfide solid electrolyte (LiI—LiBr—Li₂S—P₂S₅) 0.776 g (42% by mass)
Electroconductive material (C): Vapor-grown carbon fibers (VGCF) (manufactured by Showa Denko K. K.) 0.04 g (2% by mass)
Binder (D).: Styrene-butadiene rubber (SBR) (product name: TUFDENE 1000, manufactured by: Asahi Kasei Corporation) 0.01 g (1% by mass)
Organic solvent (E): Dehydrated heptane (manufactured by Kanto Chemical Co., Inc.) 1.7 g

Each of the numerical values in parentheses means the percentage of each taw material in the total mass of the raw materials (A) to (D).

For the VGCF (manufactured by Showa Denko K. K.) used, as the electroconductive material, the aspect ratio was 40, and the fiber diameter was 150 nm.

The aspect ratio of the VGCF was obtained as follows: 200 carbon fibers were randomly selected and observed with a scanning electron microscope (SEM); for each carbon fiber, the diameter a of a section and the length b were identified from an observed image, and the ratio b/a were calculated; the average of the ratios b/a of the selected carbon fibers was determined as the aspect ratio of the VGCF.

The fiber diameter of the VGCF was obtained as follows: 200 carbon fibers were randomly selected and observed with the scanning electron microscope (SEM); the diameters of sections of the carbon fibers were identified from an observed image, and the average of the diameters was calculated and determined as the fiber diameter of the VGCF.

The ratio of the electroconductive material (C) and binder (D) contained in the anode mixture raw material was as follows: with respect to 1 part by mass of the electroconductive material (C), the binder (D) was 0-25 part by mass.

The organic solvent (E) was 48% by mass of the total mass of the raw materials (A) to (E) for the anode mixture.

The mixture in the container was stirred for 60 seconds by an ultrasonic homogenizer (product name: UH-50, manufactured by: SMT) to obtain an anode mixture raw material in a paste form. Next, the anode mixture raw material was applied onto a substrate by an applicator and then dried at 100° C. for 60 minutes, thereby obtaining an anode mixture in a film form.

### Example 2

An anode mixture (Example 2) was produced in the same manner as Example 1, except that the binder (D) was changed from 0.01 g of the styrene-butadiene rubber (SBR) to: 0.01 g of a styrene-isobutylene-styrene copolymer (SIBS) (product name: 102T, manufactured by: Kaneka Corporation).

### Example 3

An anode mixture. (Example 3) was produced in the same manner as Example 1, except that the organic solvent (E) was changed from 1.7 g of the dehydrated heptane to 1.7 g of 1,3,5-trimethylbenzene (manufactured by Kanto Chemical Co., Inc.)

### Example 4

An anode mixture (Example 4) was produced in the same manner as Example 1, except that the organic solvent (E) was changed from 1.7 g of the dehydrated heptane to 1.7 g of isopropylbenzene (manufactured by Nacalai Tesque, Inc.)

### Example 5

An anode mixture (Example 5) was produced in the same manner as Example 1, except that the, organic solvent (E) was changed from 1.7 g of the dehydrated heptane to 1.7 g of methyl phenyl ether (manufactured by Kanto Chemical Co., Inc.)

### Comparative Example 1

An anode mixture (Comparative Example 1) was produced in the same manner as Example 1, except that the binder (D) was changed from 0.01 g of the styrene-butadiene rubber (SBR) to 0.02 g of a polyvinylidene fluoride-hexafluoropropylene copolymer (PVdF-HFP) (product name: SOLEF 21510, manufactured by: Nippon Solvay K. K.), and the organic solvent (E) was changed from 1.7 g of the dehydrated heptane to 2.5 g of butyl butyrate (manufactured by Kishida Chemical Co., Ltd.)

### Comparative Example 2

An anode mixture (Comparative Example 2) was produced in the same manner as Example 1, except that the electroconductive material (C) was changed from 0.04 g of the VGCF to 0.04 g of SFG10 (manufactured by TIMCAL) which is a flaky carbon material.

For the SFG10 used as the electroconductive material (C), the aspect ratio was 8, and the fiber diameter was 1.2 μm.

The aspect ratio and fiber diameter of the SFG10 were measured in the same manner as the measurement of the aspect ratio and fiber diameter of the VGCF in Example 1.

### Comparative Example 3

An anode mixture (Comparative Example 3) was produced in the same manner as Example 1, except that the binder (D) was changed from 0.01 g of the styrene-butadiene rubber (SBR) to 0.01 g of butadiene rubber (BR) (product name: DIENE NF35R, manufactured by: Asahi Kasei Corporation).

### Comparative Example 4

An anode mixture (Comparative Example 4) was produced in the same manner as Example 1, except that the binder CD) was changed from 0.01 g of the styrene-butadiene rubber (SBR) to 0.01 g of butadiene rubber (BR), and the organic solvent (E) was changed from 1.7 g of the dehydrated heptane to 1.7 g of 1,3,5-trimethylbenzene.

### Comparative Example 5

An anode mixture (Comparative Example 5) was produced in the same manner as Example 1, except that the electroconductive material (C) was changed from 0.04 g of the VGCF to 0.04 g of SFG10, and the binder (D) was changed from 0.01 g of the styrene-butadiene rubber (SBR) to 0.01 g of butadiene rubber (BR).

### 2. Production of All-Solid-State Lithium Ion Secondary Battery

### (1) Step of Producing Cathode Mixture

The following raw materials for the cathode were put in a container.
Cathode active material: LiNi_{1/3}Co_{1/3}Mn_{1/3}O₂ particles. (surface-treated particles with LiNbO₃, manufactured by Nichia Corporation) 1.5 g
Solid electrolyte: The above-mentioned sulfide solid electrolyte (LiI—LiBr—Li₂S—P₂S₅) 0.239 g
Electroconductive material: VGCF (manufactured by Showa Denko K. K.) 0.023 g
Binder: PVdF (manufactured by Kureha Corporation) 0.011 g
Dispersion medium: Butyl butyrate (manufactured by Kishida Chemical Co., Ltd.) 0.8 g

The mixture in the container was stirred for 60 seconds by the ultrasonic homogenizer (product name: UH-50, manufactured by: SMT) and then appropriately dried to obtain a cathode mixture.

### (2) Step of Assembling Battery

First, 0.065 g of the sulfide solid electrolyte (LiI—LiBr—Li₂S—P₂S₅) was weighed out, put in a ceramic mold having a base area of 1 cm², and then pressed at a press pressure of 1 ton/cm² to produce a solid electrolyte layer (separate layer).

Next, 0.018 g of the cathode mixture was weighed out, placed on one surface side of the produced solid electrolyte layer (separate layer) and then pressed at a press pressure of 1 ton/cm² to produce a cathode.

Next, 0.0054 g of any one of the anode mixtures of Examples 1 to 5 and Comparative Examples 1 to 5, which were in a sheet form, was weighed out, placed on the other surface side of the solid electrolyte layer (separate layer) and then pressed at a press pressure of 4 ton/cm² to produce an anode.

Next, an aluminum foil was stacked on the produced cathode to form a cathode current collector. A copper film was stacked on the produced anode to form an anode current collector. Therefore, an all-solid-state lithium ion secondary battery was obtained.

Using the anode mixtures of Examples 1 to 5 and Comparative Examples 1 to 5, all-solid-state lithium ion secondary batteries were produced in this manner.

### 3. Evaluation

### (1) Measurement of Internal Resistance During Charge and Discharge Cycles

### (i) Initial Charging and Discharging

Each all-solid-state lithium ion secondary battery was charged to 4.35 V at a current value (charge rate) of 0.245 mA, under the condition of constant voltage-constant current. Then, the battery was discharged to 3.00 V at a current value (discharge rate) of 0.245 mA, under the condition of constant voltage-constant current.

### (ii) Measurement of Initial Internal Resistance

Next, the all-solid-state lithium ion secondary battery was charged to 3.7 V at a current value of 0.245 mA and then discharged for 5 seconds at 7.35 mA. The voltage value of the battery during the discharging was measured with a charging and discharging device. (manufactured by Toyo System Co., Ltd.) From a change in voltage value thus measured, the internal resistance was calculated.

(iii) Charge and Discharge Cycles

The lithium ion secondary battery subjected to the initial internal resistance measurement in (ii) was placed in a thermostat bath controlled at 60° C. this state, the battery carried out 300 charge and discharge cycles in a voltage range of from 3.2 V to 4.2 V, under the condition of constant current at a current value of 4.9 mA.

### (iv) Measurement of Internal Resistance After Charge and Discharge Cycles

Next, after the 300 charge and discharge cycles in (iii), the lithium ion secondary battery further carried out initial charging and discharging, described in (i). Then, the internal resistance measurement of the battery was carried out in the same Manner as described in (ii).

An internal resistance increase amount was calculated by deducting the initial internal resistance value measured in (ii) from the internal resistance value measured in (iv).

For Examples 1 to 5 and Comparative Examples 2 to 5, Table 1 shows their specific internal resistance increase amounts when the internal resistance increase amount of Comparative Example 1 is determined as 100%.

The following Table 1 shows the specific internal resistance increase amounts of Examples 1 to 5 and Comparative Examples 1 to 5, in combination with the information on the electroconductive Material (C), the binder (D) and the organic solvent (E).

TABLE 1

| | | | | | | | | | | Evaluation |
|---|---|---|---|---|---|---|---|---|---|---|
| | Anode mixture raw material | | | | | | | | | Specific |
| | Anode mixture | | | | | | | | | internal |
| | Electroconductive material (C) | | | | Binder (D) | | | | | resistance |
| | | | Fiber | Content | | | Content | Organic solvent (E) | | increase |
| | | Aspect | diameter | (% by | | Aromatic | (% by | | Aromatic | amount |
| | Type | ratio | (nm) | mass) | Type | rings | mass) | Type | rings | (%) |
| Example 1 | VGCF | 40 | 150 | 2 | SBR | Present | 1 | n-Heptane | Not | 79 |
| | | | | | | | | | present | |
| Example 2 | VGCF | 40 | 150 | 2 | SIBS | Present | 1 | n-Heptane | Not | 85 |
| | | | | | | | | | present | |
| Example 3 | VGCF | 40 | 150 | 2 | SBR | Present | 1 | 1,3,5- | Present | 69 |
| | | | | | | | | Trimethylbenzene | | |
| Example 4 | VGCF | 40 | 150 | 2 | SBR | Present | 1 | Isopropylbenzene | Present | 71 |
| Example 5 | VGCF | 40 | 150 | 2 | SBR | Present | 1 | Methyl phenyl | Present | 70 |
| | | | | | | | | ether | | |
| Comparative | VGCF | 40 | 150 | 2 | PVdF- | Not | 1 | Butyl butyrate | Not | 100 |
| Example 1 | | | | | HFP | present | | | present | |
| Comparative | SFG10 | 8 | 1200 | 2 | SBR | Present | 1 | n-Heptane | Not | 128 |
| Example 2 | | | | | | | | | present | |
| Comparative | VGCF | 40 | 150 | 2 | BR | Not | 1 | n-Heptane | Not | 117 |
| Example 3 | | | | | | present | | | present | |
| Comparative | VGCF | 40 | 150 | 2 | BR | Not | 1 | 1,3,5- | Present | 113 |
| Example 4 | | | | | | present | | Trimethylbenzene | | |
| Comparative | SFG10 | 8 | 1200 | 2 | BR | Not | 1 | n-Heptane | Not | 150 |
| Example 5 | | | | | | present | | | present | |

### 3. Consideration

As shown in Table 1, the specific internal resistance increase amounts of Examples 1 to 5 are considerably smaller than those of Comparative, Examples 2 and 5 in which a fibrous carbon material is not used as the electroconductive material (C). The reason is considered as follows. In the all-solid-state lithium ion secondary batteries of Examples 1 to 5, the fibrous carbon material (VGCF) serving as the electroconductive material (C) in the anode mixture, is in good contact with the anode active material (A), compared to the flaky carbon material, and since the dispersibility of the fibrous carbon material (VGCF) was increased by the binder (D), which is a polymer compound having aromatic rings, the contact between the electroconductive material (C) and the anode active material (A) was increased, and formation of a poor contact part between the electroconductive material and the anode active material was suppressed.

Meanwhile, Comparative Examples 1, 3 and 4 used the fibrous carbon material as the electroconductive material (C). However, the specific internal resistance increase amounts of Comparative Examples 1, 3 and 4 are high, compared to Examples 1 to 5. The reason is considered as follows. Since Comparative Examples 1, 3 and 4 did not use a polymer compound having aromatic rings as the binder (D), the aggregation state of the fibrous carbon material (C) was not resolved in the anode mixture raw material and in the anode mixture, and contact between the electroconductive material (C) and the anode active material (A) was not sufficiently increased; therefore, a poor contact part was formed between the electroconductive material and the, anode active material.

The specific internal resistance increase amounts of Examples 3 to 5 in which the anode mixture was produced by use of the anode mixture raw material prepared by using the polymer compound having the aromatic rings as the binder (D) and using the organic solvents having the aromatic rings as the organic solvent (E), are further lower than the specific internal resistance increase amounts of Examples 1 and 2. The reason is considered as follows. In the anode mixture raw material, the dispersibility of the fibrous carbon material (VGCF) was further increased by the binder (D) that was the polymer compound having the aromatic rings, and the organic solvent (E) having the aromatic rings.

1. An anode mixture for all-solid-state lithium ion secondary batteries, comprising an anode active material (A), a solid electrolyte (B), an electroconductive material (C) and a binder (D),
wherein the anode active material (A) comprises Si;
wherein the solid electrolyte. (B) comprises a sulfide solid electrolyte;
wherein the electroconductive material (C) comprises a fibrous carbon material having six-membered carbon rings; and
wherein the binder (D) comprises a polymer compound having aromatic rings.

2. The anode mixture according to claim 1, wherein vapor-grown carbon fibers are contained as the fibrous carbon material.

3. The anode mixture according to claim 1, wherein the fibrous carbon material has an aspect ratio of from 10 to 100 and a fiber diameter of from, 10 nm to 600 nm.

4. The anode mixture according to claim 1, wherein at least one selected from the group consisting of styrene-butadiene rubber and a styrene-isobutylene-styrene copolymer is contained as the polymer compound.

5. The anode mixture according to claim 1, wherein at least one lithium compound selected from the group consisting of Li₂S, LiBr and LiI, and at least one sulfur compound selected from the group consisting of P₂S₅ and SiS₂ are contained as the sulfide solid electrolyte.

6. A method for producing an anode mixture for all-solid-state lithium ion secondary batteries, the method comprising:
an anode mixture raw material preparing step (I) of preparing an anode mixture raw material comprising an anode active material (A) comprising Si, a solid electrolyte (B) comprising a. sulfide solid electrolyte, an electroconductive material (C) comprising a fibrous carbon material having six-membered carbon rings, a binder (D) comprising a polymer compound having aromatic rings, and pan organic solvent (E) having aromatic rings, and
a drying step (II) of drying the anode mixture raw material.

7. The production. method according to claim 6, wherein the method comprises, before the drying step (II), an applying step of applying: the anode mixture raw material to a substrate, and the applied anode mixture raw material is dried in the drying step (II).

8. The production method according to claim 6, wherein vapor-grown carbon fibers are used as the fibrous carbon material.

9. The production method according to claim 6, wherein the fibrous carbon material has an aspect ratio of from 10 to 100, and a fiber diameter of from 10 nm to 600 nm.

10. The production method according to claim 6, wherein at least one selected from the group consisting of styrene-butadiene rubber and a styrene-isobutylene-styrene copolymer is used as the polymer compound having the aromatic rings.

11. The production method according to claim 6, wherein at least one selected from the group consisting of 1,3,5-trimethylbenzene, isopropylbenzene and methyl phenyl ether is used as the organic solvent (E).
